(19) United States
(12) Patent Application Publication
(10) Pub. No.: US 2019/0057183 A1
(43) Pub. Date: Feb. 21, 2019

(54) MACHINE BASED CLASSIFIER FOR GENETIC INTERACTIONS

(71) Applicants: Gang Fang, Chappaqua, NY (US); Wen Wang, Shoreview, MN (US); Vipin Kumar, Plymouth, MN (US); Chad L. Myers, Arden Hills, MN (US)

(72) Inventors: Gang Fang, Chappaqua, NY (US); Wen Wang, Shoreview, MN (US); Vipin Kumar, Plymouth, MN (US); Chad L. Myers, Arden Hills, MN (US)

(21) Appl. No.: 16/079,664

(22) PCT Filed: Mar. 14, 2017
(86) PCT No.: PCT/US17/22308

§ 371 Date: Aug. 24, 2018

Related U.S. Application Data
(60) Provisional application No. 62/308,029, filed on Mar. 14, 2016.

(51) Int. Cl. G06F 19/12; G06F 19/18

(52) U.S. Cl. CPC G06F 19/12; G06F 19/18

(57) ABSTRACT

The present disclosure provides a computer implemented method. The method includes using a computer processor to perform the operations of constructing a nucleic acid mutation interaction network based upon nucleic acid pair-level interactions of a genetic sample scored under at least one disease model. The method further includes performing a thresholding and binarization process on the nucleic acid pair interactions to derive an interaction network. The method further includes testing pairs of pathways of the interaction network for either between pathway model (BPM) or within pathway model (WPM) enrichment of nucleic acid-nucleic acid mutation pair interaction. The method additionally includes outputting nucleic acid-nucleic acid mutation pair interaction data.

### CROSS-REFERENCE TO RELATED APPLICATION

This application claims the benefit of priority to U.S. Provisional Patent Application Ser. No. 62/308,029 entitled “MACHINE BASED CLASSIFIER FOR GENETIC INTERACTIONS BETWEEN PATHWAYS OF GENOME-WIDE ASSOCIATIONS,” filed Mar. 14, 2016, contents of which are hereby incorporated by reference.

### GOVERNMENT RIGHTS

This invention was made with government support under IIS 0916439 and DBI 0953881 awarded by The National Science Foundation. The government has certain rights in the invention.

This invention was made with government support under R01HG005084 and R01HG005853, R01MH097276, and R01GM114472 awarded by National Institutes of Health. The government has certain rights in the invention.

### TECHNICAL FIELD

Embodiments pertain to approaches for computing genetic interactions between pathways.

### BACKGROUND

Genetic interactions may be an important factor in complex disease that contributes to unexplained or so-called “missing heritability” in genome-wide association studies (GWAS). However, the existing methods for identifying genetic interactions, which tend to focus on testing individual locus pairs, lack statistical power and thus remain compromised for exploring the underlying association of genetic interactions with inherited phenotypes.

### BRIEF DESCRIPTION OF THE DRAWINGS

In the drawings, which are not necessarily drawn to scale, like numerals can describe similar components in different views. Like numerals having different letter suffixes may represent different instances of similar components. The drawings illustrate generally, by way of example, but not by way of limitation, various embodiments discussed in the present document.

FIG. 1 is a flowchart of the BridGE method for detecting genetic interactions from GWAS data according to some examples of the present disclosure.

FIG. 2 is a diagram that illustrates between pathway model of genetic interactions according to some examples of the present disclosure.

FIG. 3 is a diagram that illustrates the bipartite structure of genetic interactions resulting from functional compensation between the two pathways shown in FIG. 2 according to some examples of the present disclosure.

FIG. 4 is a chart that illustrates a quantile-quantile (QQ) plot comparing observed p-values (based on 100,000 SNP-pathway membership permutations) for all possible pathway-pathway interactions between the 685 pathways to the expected, uniform distribution (log 10 scale) according to some examples of the present disclosure.

FIG. 5 is a chart that illustrates a null distribution of the SNP-SNP interaction density between the Golgi associated vesicle biogenesis pathway and Fc epsilon receptor I signaling pathway shown in FIG. 4 based on 100,000 SNP permutations according to some examples of the present disclosure.

FIG. 6 is a chart that illustrates distribution of p-values from individual tests for pairwise SNP-SNP interactions for SNP pairs supporting the pathway-pathway interaction, as measured by an additive disease model (−log 10 p-value) according to some examples of the present disclosure.

FIG. 7 is a diagram that illustrates a network representation of a set of significant (FDR≤0.25) between-pathway (BPM) and within-pathway interactions (WPM) that are associated with increased or decreased risk of Parkinson's disease (PD) according to some examples of the present disclosure.

FIG. 8 is a chart that illustrates statistical significance for validating Between Pathway Model (BPM) and Within Pathway Model (WPM) interactions discovered from PD-NIA data according to some examples of the present disclosure.

FIG. 9 is a chart that illustrates a scatter plot of the significance of SNP-SNP interaction overlap in each of the replicated BPMs (−log 10 hypergeometric p-value) versus a direct measure of overlap (Jaccard similarity) according to some examples of the present disclosure.

FIG. 10 is a block diagram illustrating an example of a machine upon which one or more embodiments may be implemented.

### DETAILED DESCRIPTION

Disclosed herein are methods, systems, and machine readable mediums, for implementing a technique referred to hereinafter as BridGE (Bridging Genes with Epistasis) for explicitly searching for coherent sets of mutation-mutation interactions within genome-wide association studies (GWAS) cohorts that connect groups of genes corresponding to characterized pathways or functional modules. Although many pairs of loci do not have statistically significant interactions when considered individually, they can be collectively significant if there is an enrichment of mutation-level interactions between two functionally coherent sets of genes forming a Between Pathway Model (BPM) or Within Pathway Model (WPM) genetic network structure.

Genome-wide association studies have been increasingly successful at identifying various nucleic acid mutations such as insertion mutations, deletion mutations, frameshift mutations, or single-nucleotide polymorphisms (SNPs), at various loci, with statistically significant association to a variety of diseases and gene sets significantly enriched for various mutations with moderate association. The mutation can be determined by any genotyping approach (e.g. microarrays, whole-genome/exome sequencing).

While identification of these mutations can help to identify disease risk in an individual, for most diseases, there remains a substantial disparity between the disease risk explained by the discovered loci and the estimated total heritable disease risk based on familial aggregation, a problem that has been referred to as “missing heritability.” While there are a number of possible explanations for missing heritability, genetic interactions between loci are one potential cause. Genetic interactions generally refer to a combination of two or more genes whose contribution to a phenotype (e.g., a disease) cannot be explained by their independent effects, but rather by their interactions. These interactions can play an important role in the presence and development of various phenotypes. For example the genetic interactions can play a role in the presence of various diseases.

Detecting interactions between genetic variants in various phenotype contexts with statistical significance is currently a major challenge. For example, it is thought that, through simulation studies, approximately 500,000 subjects would be needed to detect significant genetic interactions under reasonable assumptions, which is beyond the cohort sizes currently available for a standard GWAS study (or even the great majority of meta-GWAS studies).

However, GWAS studies for associating mutations in genetic interactions is an appealing target. Particularly so, when genome-wide reverse genetic screens in model organisms have produced insights into the prevalence and nature of genetic interactions, leading to insights that can benefit the discovery of disease-associated genetic interactions in the GWAS context. For example, a global analysis of the yeast genetic interaction network suggests that genetic interactions tend to cluster in particular network structures, connecting across functionally compensatory modules (pathways or protein complexes) as opposed to existing as isolated instances.

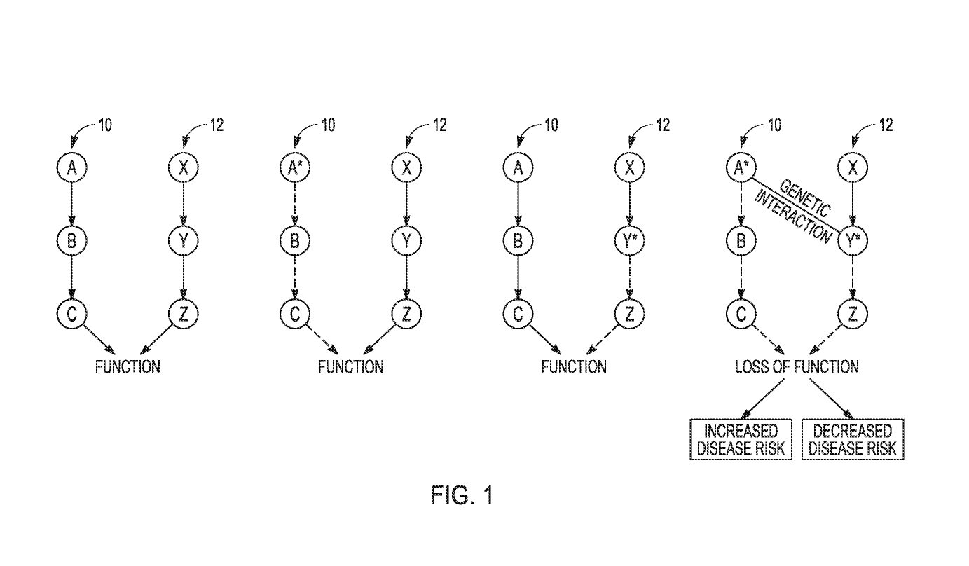

To illustrate this example, it can be imagined that in an organism there are two distinct pathways. Pathway 10 can include, for example, components A→B→C. Pathway 12 includes, for example, components X→Y→Z, both of which impinge on a common biological process, as shown in the flow chart of FIG. 1. As a non-limiting example, any one of A, B, C, D, X, Y, or Z can be a protein (e.g., an enzyme) or a gene encoding a protein responsible for performing one, or more, functions in the pathway. Any of A, B, C, D, X, Y, or Z denoted with an asterisks mean that a mutation is present in the gene associated with the some component. In some examples, due to their functional redundancy, the two different pathways can compensate for the loss of the other, and thus, a genetic mutation in either of the two pathways independently may not cause a particular phenotype. However, joint mutations in, for example. A and Y would disrupt both pathways and the resulting loss of function can be associated with either increased or decreased disease likelihood of a particular phenotype (e.g., increased or decreased risk of a disease).

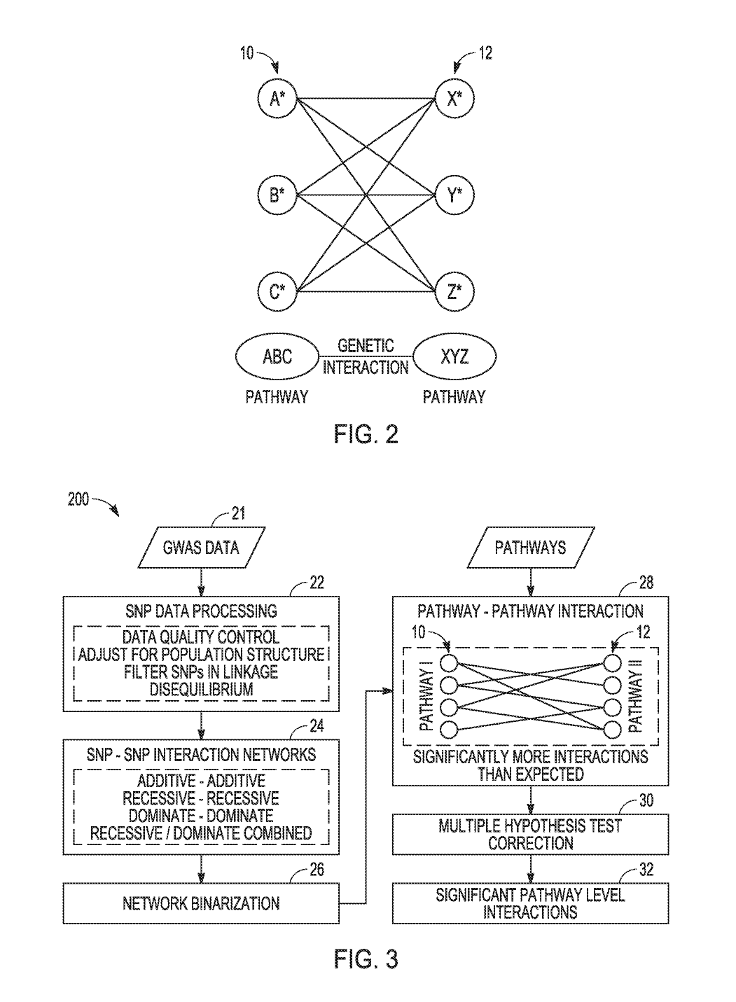

The same phenotypic outcome could be achieved by several other paired genetic perturbations (e.g. A-X, A-Z, B-X, B-Y, B-Z, as summarized in FIG. 1). As shown in FIG. 2 Distinct pathways, 10 (A→B→C) and 12 (X→Y→Z) both contribute to a common biological process. Independent genetic perturbations in either pathway (indicated with an asterisk) have little or no contribution to a phenotype, but combined perturbations in both pathways in the same individual result in a genetic interaction that can be associated with either an increase or decrease in disease risk. Although 18 different interactions are in total are shown the number of interactions can be higher or lower. This model for how genetic interactions should naturally arise, commonly called the “between pathway model” (BPM), can be observed in yeast genetic interaction networks. Another scenario, from screens in model organisms, is that combinations of mutations in genes within the same pathway or protein complex exhibit a high frequency of genetic interaction, a scenario termed the “within-pathway model” (WPM). This can be particularly frequent among partial loss-of-function variants in essential protein complexes (˜80% of essential protein complexes exhibit a significantly elevated frequency of within-pathway interactions).

In combination, these local between-pathway and within-pathway structures can be estimated to account for as many as ˜70% of negative genetic interactions observed in yeast, suggesting this type of local clustering of interactions is common. Other work in yeast exploited this structure to derive genetic interaction networks from phenotypic variation in a yeast recombinant inbred line population.

The observation that BPM and WPM structures explain a large majority of observed genetic interactions in model organisms has important practical implications in the human GWAS context. Specifically, genetic interactions can be detected by using the observation that pairwise interactions between genome variants will likely cluster into larger network structures despite the fact that mutation level or gene level pairwise interaction tests are statistically under-powered.

In some examples, for detecting interactions and predicting phenotypes as described herein involves the operations shown in the flow chart of FIG. 3. The method 20 involves operation 22 in which data processing of GWAS data 21 occurs. The data processing may include one or more (or all) of: sample quality control, adjustment for population substructure between the cases and controls to avoid false discoveries due to population stratification, and controlling for linkage disequilibrium (LD) by pruning the full set of SNPs into a subset. LD could otherwise result in spurious BPM or WPM substructures.

The method further includes operation 24, which includes construction of mutation-mutation interaction networks based on mutation pair-level genetic interactions scored under different disease model assumptions (additive, recessive, dominant or combinations of recessive and dominant models). The method further includes operation 26, which includes network thresholding and binarization by applying a threshold to derive a low-confidence, high-coverage interaction network. In some examples, the threshold is lenient. The method further includes operation 28 in which pairs of pathways, as defined by curated functional standards, are tested for BPM or WPM enrichment of SNP-SNP pair interactions with a chi-squared test, compared to both the global interaction density (X_{global}²) and the marginal interaction density of the two pathways (X_{local}²), as well as a permutation test (pₚₑᵣₘ) conducted by randomly shuffling the SNP-pathway assignment. The method further includes operations 30 and 32 in which a sample permutation strategy is used to estimate false discovery rate to correct for multiple hypothesis testing and assess the significance of the discovered BPM or WPM. A significant pathway-level interaction can be associated with either increased risk of disease (pairs of minor alleles linking two pathways are more frequent in the diseased population) or decreased risk of disease (pairs of minor alleles linking two pathways are more frequent in the control population).

In some examples, the analysis of the data can include a quality control operation 22. The data quality control operation 22 can be controlled using a PLINK inclusion procedure. In examples where SNPs are analyzed the PLINK procedure can be set with the following parameters: a maximal missing genotyping rate for each individual/SNP (--mind, --geno) can be in a range from 0.01 to 0.10 or 0.02, 0.05. A minimum minor allele frequency (--maf) can be in a range from 0.01 to 0.10, or 0.05. A Hardy-Weinberg equilibrium cutoff can be in range from 0.5×10⁻⁶ to 2.0×10⁻⁶, or 1.0×10⁻⁶ (--hwe 1×10⁻⁶). These parameters are examples and any other suitable value can be used depending on the particular application.

When the genotype data is gathered, the data is analyzed to identify outlier samples that are not consistent with the reported study population. That is, if the genotype of one sample differs substantially from those of members of the reported population for that study, that data is removed.

Mutations (e.g., SNPs) in each GWAS data set can be mapped to Genome Reference Consortium GRCh37, which can be combined with the 1000 Genomes project database (PM18327223). Comparing the genotypes of the study populations to these references can be used to confirm whether the study population's genotype substantially matches the corresponding population in the 1000 Genomes project database.

Once the mutations are mapped, the PLINK methods can be used to perform multi-dimensional scaling (MDS) analysis. The MDS analysis can be used to generate an MDS plot. Based on the MDS plot, gene samples that are not tightly clustered with the corresponding ancestry groups in the 1000 Genomes data are removed.

After the genotype data is mapped, relatedness among pairs of subjects is tested by calculating the identical by decedent (IBD) factor for pairs. IBD is relevant to the extent that two genes share the same sequence. As an example a gene, or segment thereof, is identical by state (IBS) in two or more individuals if they have identical nucleotide sequences. An IBS segment is identical by descent (IBD) in two or more individuals if they have inherited it from a common ancestor without recombination, that is, the segment has the same ancestral origin in these individuals. DNA segments that are IBD are IBS per definition, but segments that are not IBD can still be IBS due to the same mutations in different individuals or recombinations that do not alter the segment. For subject pairs with a proportion IBD score greater than 0.2, one is randomly chosen and removed from the data, and the other is kept.

Of those genes that are kept they are split into case genes and control genes. Spurious allelic associations can be discovered due to unknown population structure. Therefore, GWAS analyses practice includes the use of a procedure to ensure balanced population structure between cases and controls. Accordingly, the genes in each population can be clustered into groups of size 2, each containing one case gene and one control gene that are from the same sub-population (based on pairwise identity-by-state distance and the corresponding statistical test). This can be accomplished in conjunction with an open source C/C++ GWAS tool such as PLINK (as described in S. Purcell et al., PLINK: a tool set for whole-genome association and population-based linkage analyses).

After the case and control genes are established, the mutations can be filtered for those mutations in linkage disequilibrium (LD). As is generally understood, linkage disequilibrium is the non-random association of alleles at different loci. Loci are said to be in linkage disequilibrium when the frequency of association of their different alleles is higher or lower than what would be expected if the loci were independent and associated randomly.

To filter the mutations, all mutations, such as SNPs, that can be mapped to at least one of the 6744 genes in the collection of pathways used in the pathway-pathway interaction search are selected. As an example, an SNP can be mapped to all genes that overlap with a +/−50 kb window centered at the SNP, and then mapped to pathways to which the corresponding gene(s) are annotated. A SNP is only associated once with each pathway, even if it mapped to multiple genes in the pathway.

To avoid the discovery of trivial bipartite structures, mutations in linkage disequilibrium (LD) may be removed before between or within-pathway enrichment of mutation-mutation interactions is conducted. Two general approaches can be used: 1) removing mutations in LD before calculating pairwise mutation-mutation interactions; and 2) removing structures that emerge as a result of mutations in LD after calculating pairwise mutation-mutation interactions.

The first alternative may miss more informative mutation-mutation interactions than the second because it only considers a subset of all mutations, but it is more computationally efficient and scalable.

To filter the genes and select a subset, a procedure in PLINK can be used, in which for example the mutations are SNPs, PLINK searches each window of 50 SNPs with a sliding step of 5 SNPs, and selects a subset of SNPs with pairwise r2 below 0.1 within each sliding window. After this procedure, 15,000˜20,000 SNPs are left in each dataset, and the highest r2 between any pair of SNPs within any window of 1 Mb is lower than the commonly used threshold for controlling LD (r2<0.2). This demonstrates that the LD was effectively controlled. Although using an r2 threshold of 0.1 can result in some informative SNPs being ignored, the approach can minimize the chance that spurious BPMs resulted from remaining LD structure.

Once the genes are filtered, they are mapped to a set of pre-defined pathways. For example, in applications involving humans, 833 human pathways (gene sets), can be collected from a sources such as the Kyoto Encyclopedia of Genes and Genomes (KEGG), Biocarta, and Reactome. The disclosure fully appreciates that more pathways may be established in the future and notes that these operations can be applied to those too. While not necessary in each instance, a pathway can be excluded from analysis if it has less than 10 or more than 300 genes or mutations mapped. In appropriate circumstances this can be done in order to avoid pathways that can be too small to provide sufficient statistical power or can be too large to provide specific biological insight.

After the genes are mapped, the interaction between mutations is estimated at operation 24. For example, when determining an SNP-SNP genetic interaction estimation MM, Mm and mm are used to denote the three genotypes of each SNP, (e.g., majority homozygous (MM), heterozygous (Mn) and minority homozygous (mm). A minor allele (m) at each locus could be additive, dominant or recessive in the context of different diseases. In the additive model, a logistic regression-based model implemented in a C++ program such as “Contrived Acronym of Software for SNP Interactions” (CASSI). Briefly stated in CASSI, SNP-SNP interactions are analyzed from a choice of SNPs from two given SNP windows (possibly from different pedigree files). Each pair of SNPs whose interaction test passes a given significance level is returned in the output file with possible extra information. The program can accept PLINK output.

Using the interaction between two SNPs can be coded as follows, mm=2, Mm=1, MM=0. In this model, the goodness-of-fit can be compared between a standard logistic regression with an interaction term and a standard logistic regression without an interaction term, and the significance can be measured by a likelihood ratio test. Such an interaction is referred to herein as an additive-additive (AA) model based interaction. In the dominant model, a SNP is encoded as mm=1, Mm=1, MM=0. In the recessive model, a SNP is encoded as mm=1, Mm=0, MM=0. Because the minor allele can be either recessive (R) or dominant (D) at two different loci comprising an interaction, four types of SNP-SNP interactions can be examined: recessive-recessive (RR) model-based interaction, dominant-dominant (DD) model-based interaction, recessive-dominant (RD) model-based interaction and dominant-recessive (DR) model-based interaction for each pair of SNPs. The interactions under these four models can also be estimated by a logistic regression-based model similar to the AA-based interaction except that the encoding of the SNP genotypes is different. Alternatively, the RR, DD, DR and RD interactions can also be estimated by explicit statistical tests (e.g. hypergeometric tests or other statistical measures) of the association between a specific genotype combination of two SNPs and a disease of interest and the association between each of the individual SNPs and the disease. Interactions estimated by logistic regression based models directly capture non-additive effects between two SNPs considering different combinations of SNP genotypes. In contrast, interactions estimated by explicit statistical tests have the flexibility of specifically testing certain combinations of genotypes. While both different ways of representing disease models and different ways of estimating interactions are contemplated, in some examples, RR, DD. DR and RD interactions estimated by explicit statistical tests can lead to the discovery of significant BPMs/WPMs.

To estimate the interactions between two binary-coded SNPs (dominant or recessive as described herein), a hypergeometric-based measurement (hygeSSI) is designed. The hypergeometric p-value for a pair of binary-coded SNPs with respect to a case-control cohort is calculated as follows:

$$\begin{matrix}{P}_{T} ( {S}_{x} , {S}_{y} , C ) = 1 - hygecdf ( X - 1 , M , K , N ) \\ = 1 - {\sum }_{f = 0}^{X} \frac{( \begin{matrix}K \\ F\end{matrix} ) ( \begin{matrix}M - K \\ N - f\end{matrix} )}{( \begin{matrix}M \\ N\end{matrix} )}\end{matrix}$$

where Sₓ and S_{y} are two SNPs; M is total the number of samples; N is total number of samples in class C; K is the total number of samples that have genotype T; X is the total number of samples that have genotype T in class C.

P_{1˜}(Sₓ, C) and P_{˜1}(S_{y}, C) are used to represent the individual SNP Sₓ and S_{y}'s main effects and P₁₁(Sₓ, S_{y}, C), P₁₀(Sₓ, S_{y}, C), P₀₁(Sₓ, S_{y}, C) and P₀₀(Sₓ, S_{y}, C) are used to represent the effects of all pairs of combinations. With a nominal p-value threshold (α=0.05), in some examples, a SNP pair is required to have significant association with the phenotype (P₁₁ (Sₓ, S_{y}, C)≤α). Among those SNP pairs that meet this requirement, the following measure hygeSSI (Hypergeometic SNP-SNP Interaction) can be defined to estimate the genetic interaction between two SNPs Sₓ and S_{y} (specifically for P11):

$${hygeSSI}_{C} ( {S}_{x} , {S}_{y} ) = \{ \begin{matrix}- {log}_{10} \frac{{P}_{11} ( {S}_{x} , {S}_{y} , C )}{\begin{matrix}min \{ {P}_{10} ( {S}_{x} , {S}_{y} , C ) , {P}_{01} ( {S}_{x} , {S}_{y} , C ) , \\ {P}_{00} ( {S}_{x} , {S}_{y} , C ) , {P}_{1 ∼} ( {S}_{x} , C ) , {P}_{∼ 1} ( {S}_{y} , C ) \}\end{matrix}} \\ 0 ; {P}_{11} > α , {P}_{10} , {P}_{01} , {P}_{00} \leq α\end{matrix}$$

The first component in the definition favors SNP pairs with P₁₁(Sₓ, S_{y}, C) values that are more significant than five other p values (either from the associations between other genotype combinations and C or the marginal association between the two SNPs and C). In addition, instances where other genotype combinations show significant association with C are specifically excluded, e.g., the following is true: P₁₀(Sₓ, S_{y}, C)>α, P₀₁(Sₓ, S_{y}, C)>α and P₀₀(Sₓ, S_{y}, C)>α.

After the recessive-recessive (RR) and dominant-dominant (DD) interaction networks are computed based on the hygeSSI procedure only positive interactions are kept in the network (e.g., where the joint effect of the SNP-SNP pair under the corresponding disease model was stronger than any marginal or alternative combination of SNPs). In addition to the above three networks, a hybrid genetic interaction network can be constructed in which recessive and dominant disease model can coexist. To do this, all four networks (RR, DD, RD and DR) are integrated into a single network (RD-combined) by taking the maximum hygeSSI among the four interaction networks for each pair of SNPs.

For each pair of pathways, it can be desirable to test whether the number of mutation (e.g., SNP-SNP) interactions between them is significantly higher than expected due to random chance (e.g., with respect to the density of the SNP-SNP network, and with respect to the marginal interaction density of the two pathways). Conceptually, this is related to the existing approaches designed for gene set enrichment analysis (GSEA) originally applied on case-control gene expression datasets and then adapted to GWAS SNP datasets. However, there are two key differences.

First, traditional approaches for GSEA start from univariate statistics of genes or SNPs, while this approach is built on non-additive interactions between pairs of SNPs that could have little or no single locus association with a disease phenotype. Second, approaches for GSEA target the enrichment of single gene/SNP associations in each individual pathway while this approach explores the enrichment of SNP-SNP interactions across each pair of pathways. Beyond the conceptual difference, the pairwise pathway enrichment analysis based on SNP-SNP interactions can be much more computationally challenging Therefore, it can be desirable to binarize the hygeSSI values, by a threshold (which may be lenient), into binary interactions to make follow up computation efficient and scalable. After binarization, at operation 26, the SNP-SNP interaction network is broken into two networks based whether the joint mutation of a SNP pair is more prevalent in the case or control group, referred to as the risk and protective networks, respectively at operation 28.

For each pathway-pathway interaction, the common mutations (e.g., SNPs) shared between two pathways is first removed. Then the observed SNP-SNP interaction density between two pathways is tested to determine if it is significantly higher than expected globally (e.g., the global network density) and locally (e.g., the marginal density of SNP-SNP interactions between the two pathways). For example, the marginal density of a pathway is calculated as the SNP-SNP interaction density between the SNPs mapped to the pathway and all other SNPs in the network. A chi-square statistic is used to test differences from both global and local density, namely chi-square global (X_{global}²) and chi-square local (X_{local}²). The chi-square test assumes the mutation interaction such as SNP-SNP interactions in a network are independent, which may not be true due to a variety of reasons. Accordingly, in addition to these chi-square statistics, permutation tests are used to derive an empirical p-value for each pathway-pathway interaction. To do this, the SNP-pathway membership (NP=100,000 times) is randomly shuffled and for a given pathway-pathway interaction (bpmᵢ), its observed X_{global}² and X_{local}² are compared with the values from these random permutations (\tilde{X}_{global}² and \tilde{X}_{local}²) to obtain a permutation-based p-value.

$${p}_{perm} ( {bpm}_{i} ) = \frac{\# ( {\tilde{X}}_{global}^{2} \geq {X}_{global}^{2} ( {bpm}_{i} ) \& {\tilde{X}}_{local}^{2} \geq {X}_{local}^{2} ( {bpm}_{i} ) ) + 1}{NP}$$

The value pₚₑᵣₘ was used together with (X_{global}²) and (X_{local}²) for BPM discovery as further described in detail in the next two sections.

Because a large number of pathway pairs are tested in the search for significant BPMs, correction for multiple hypothesis testing can be necessary at operation 30. To estimate a false discovery rate, sample permutations (NP=10 times) are employed to derive the number of expected BPMS discovered by chance at each level of significance at operation 32. The original case-control groups are randomly shuffled 10 times while maintaining the matched case-control population structure. For each permuted dataset, the same pipeline for BPM discovery was performed, including calculation of the SNP-SNP interaction network after permutation, which can then be thresholded at a fixed interaction density matching the density chosen for the real sample labels. From these sample permutations, three null distributions are obtained (\tilde{X}_{global}², \tilde{X}_{local}², and \tilde{p}ₚₑᵣₘ), from which it is possible to estimate the false discovery rate (FDR) for each BPM (e.g., bpmᵢ) by comparing the number of BPMs observed in real data (X_{global}², X_{local}², and pₚₑᵣₘ) that have better overall statistics than bpmᵢ with the corresponding random expectation estimated from three null distributions (\tilde{X}_{global}², \tilde{X}_{local}², and \tilde{p}ₚₑᵣₘ):

$$FDR ( {bpm}_{i} ) = \frac{\begin{matrix}{\tilde{\# \{ X}}_{global}^{2} > {X}_{global}^{2} ( {bpm}_{i} ) \& {\tilde{X}}_{local}^{2} > {X}_{local}^{2} ( {bpm}_{i} ) \& \\ {\tilde{p}}_{perm} < {p}_{perm} ( {bpm}_{i} ) \} \text{/} 10\end{matrix}}{\begin{matrix}\# \{ {X}_{global}^{2} > {X}_{global}^{2} ( {bpm}_{i} ) \& {X}_{local}^{2} > {X}_{local}^{2} ( {bpm}_{i} ) \& \\ {p}_{perm} < {p}_{perm} ( {bpm}_{i} ) \}\end{matrix}}$$

A simpler approach to estimate FDR can include using only the SNP permutation-based p-value, pₚₑᵣₘ, in the above formula. However, choosing to use all three measurements (X_{global}², X_{local}² and pₚₑᵣₘ) in some examples, can show that the permutation-based p-value alone might not provide enough resolution to differentiate among top BPMs (although this can be improved with more than 100,000 SNP permutations). X_{global}² and X_{local}² provide higher resolution measures of significance of each BPM and, when combined with the permutation-based p-value, can differentiate among the top-most significant discoveries.

Any disease model (e.g., RR, DD. RD-combined, and AA) or interaction statistic could be used to discover pathway-level interactions. In this disclosure, prioritizing a single disease model per disease cohort for full analysis to control the complexity of data analysis across the 12 GWAS cohorts is described. As described herein, the strategy used to select the disease model to focus on for each GWAS dataset is described.

To prioritize the disease model and the mutation (e.g., SNP-SNP) interaction network density threshold for each data set, a pilot experiment can be first performed in which combinations of different disease models and different density thresholds was examined, but with fewer SNP permutations. For each combination, 10,000 SNP-pathway membership permutations (as compared to 100.000 for a complete run) can be performed to estimate FDRs. Based on this pilot experiment in each cohort, the disease model and density threshold combination can be chosen that results in the lowest estimated FDR for the top-most significant pathway-pathway interaction. The rationale of using such a pilot experiment can be to identify the disease model that is most likely to discover significant pathway-level interactions while limiting the computational burden of applying the disclosed approach to several GWAS cohorts under multiple disease models. Based on these pilot experiments, the complete BridGE pipeline can be run, including 100,000 SNP permutations and 10 sample permutations on any cohorts resulting in a discovery with estimated FDR<0.35. As an example, for Parkinson's disease and Schizophrenia where multiple cohorts of the same ancestry were present, all disease models were run that passed the pilot tests from any cohort on all available cohorts to enable tests for replication.

To determine if a discovered BPM was replicated in an independent cohort, BPM can be chosen such that X_{global}² p value ≤0.05, X_{local}² p value ≤0.05, and pₚₑᵣₘ≤0.05 on the validation cohort. A 10 sample permutation tests for each validation cohort can also be performed, from which null distributions for X_{global}², X_{local}² and pₚₑᵣₘ in the validation cohort can be produced. Given a set of discovered BPMs (e.g., FDR≤0.25), fold enrichment can be calculated by comparing the number of BPMs discovered from the original dataset that passed the validation criteria to the average number of BPMs that passed the same validation criteria in the random sample permutations. The significance of the fold enrichment can also be evaluated by 10,000 bootstrapped BPM sets.

For the BPMs that replicate in an independent cohort, The SNP-SNP interactions supporting the discovered pathway-level interactions can be checked to determine if they are similar between the cohort used for discovery and the independent cohort used for replication. For example, the BPMs discovered from PD-NIA (FDR≤0.25) were used and for each BPM replicated in PD-NGRC, SNP-SNP interactions were taken that coexist in both the PD-NIA and PD-NGRC interaction networks as supporting interactions for the BPM. The same permutation approach can be taken as that described above for BPM-level validation except that the SNP-SNP interactions supporting each BPM were compared between the discovery and validation cohorts by a hypergeometric test. This can be done for the real validation cohort PD-NGRC first and then repeated 10 times under sample permutations of the validation cohort to estimate a null distribution. A Wilcoxon's ranksum test can then be used to evaluate the significance of the SNP-SNP interaction overlap between the replicated BPMs in the real validation cohort and in the random (e.g., via sample permutations) validation cohorts.

If many of the curated gene sets overlap, redundancy can be controlled in the discovered BPMs. To accomplish this, in reporting total discoveries, BPMs can be filtered based on their relative overlap in SNP-SNP interactions using Jaccard similarity. The Jaccard similarity between two BPMs is defined as the number of overlapping SNP pairs divided by the number of possible SNP pairs in the smaller BPM.

For the significant BPMs discovered, all pairwise overlap coefficients can be computed and a maximum allowed similarity score of 0.25 can be used as a cutoff. The number of unique BPMs can be reported based on the number of connected components.

In addition to between-pathway model (BPM), enrichment of genetic interactions within each pathway can also be tested these are called within-pathway models (WPMs). All of the measures and procedures described above for BPMs apply directly to the WPM case, only in these instances SNP pairs connecting genes within the same pathways/gene sets are analyzed instead of between pathway pairs. For WPMs, the false discovery rate and validation statistics were computed separately from BPMs.

Both “between-pathway model” and “within-pathway model” analysis can be designed to avoid discoveries caused by the higher marginal interaction density of the individual pathways, pathways that are frequently interacting with many loci across the genome (as opposed to localized interactions with functionally coherent gene sets) are less likely to appear in the pathway-pathway or within-pathway interactions. However, in certain circumstances such pathways can also be disease relevant as they can reflect pathways that modify the disease risk associated with a large number of other variants, so pathways exhibiting these characteristics with BridGE (referred to as “PATH” discoveries) are also disclosed. For PATH discovery, the procedure is similar as for BPMs and WPMs, but the scoring is different. For example, each pathway is represented by a vector of pathway-associated SNPs' degrees in the SNP-SNP interaction network. A one-tailed ranksum test can then be applied to compare this pathway-associated degree vector with the non-pathway-associated degree vector to see if the PATH associated SNPs have more interactions than background SNPs. PATH discovery and validation is then be done by repeating the same steps as BPM/WPM discovery but replacing the X_{global}² and X_{local}² statistics with the ranksum test p-value (in −log₁₀ scale). Many of these also have clear relevance to the disease in which they were discovered. For example, applying BridGE to discover such “SNP-SNP hub” pathways in the context of Parkinson's disease can result in 3 significant pathways.

The interactions captured by hygeSSI can be examined to determine if they were non-additive as measured through a standard logistic regression-based interaction measure. The logistic regression model on the PD-NIA data can be applied and RR, DD, RD and DR interaction networks (binary encoding as described earlier) can be computed. These 4 logistic regression-based networks were integrated to form an RD-combined network. Then (1) if the top SNP-SNP interactions based on hygeSSI are significant (p≤0.05) in logistic regression based tests, and (2) if the significant BPMs discovered from a hygeSSI interaction network show significance (X_{global}² p value ≤0.05, X_{local}² p value ≤0.05, and pₚₑᵣₘ≤0.05) based on SNP-SNP interactions estimated from logistic regression. This analysis can reveal that among the top 1% hygeSSI interactions, 93% are significant based on a logistic regression-based test. And for the significant BPMs (FDR≤0.05), 100% of them are also significant based on SNP-SNP interactions estimated from logistic regression. This data can suggest SNP-SNP interactions captured by hygeSSI do represent non-additive interactions as defined based on logistic regression models.

For SNP-SNP pairs that supported the between-pathway interaction, the statistical significance of SNP-SNP interaction pairs tested individually can be checked. All pairwise additive-additive (AA), recessive-recessive (RR), dominant-dominant (DD) interactions can be measured. A permutation test can be performed in which sample labels are permuted 10 times and for each permutation, all pairwise AA, RR, DD interactions can be computed for each SNP pair. These permutations are used to estimate a false discovery rate (FDR) for those SNP-SNP pairs supporting the reported BPM. No individual SNP-SNP pairs are significant after multiple-hypothesis correction.

To characterize the statistical power of the approach as a function of pathway size, SNP-SNP interaction density, and marginal density of pathways, a synthetic interaction network can be generated with the same degree distribution as the PD-NIA recessive-dominant combined network at 5% density. Then two sets of non-overlapping BPMs can be embedded into this SNP-SNP interaction network while retaining the same degree distribution and density of the network: the BPMs in the first set had a marginal pathway density of 0.05 and the BPMs in the second set can have a marginal pathway density of 0.1. Each set can have 42 BPMs at 7 different sizes (number of SNPs mapped to the two pathways in each BPM: 10×10, 50×50, 100×100, 150×150, 200×200, 250×250 and 300×300; and 6 different densities 0.05, 0.06, 0.07, 0.08, 0.09 and 0.1. A 100,000 SNP-pathway membership permutations is applied to assess the significance of these embedded patterns.

The output of the disclosed algorithms can be displayed on one or more graphical displays. The results of the algorithm may then be used in many ways. For example, it can be used to determine genetic components of disease, which not only can be utilized to develop new pharmaceuticals to target the disease but also can be used in genetic disease screening program for prevention, early diagnosis. The identification of genes responsible for disease may also allow for genetic engineering and gene therapy to improve disease outcomes.

As another example, the disclosed methods may be used in animal breeding applications in which breeders may screen male and female animals prior to breeding to select the best animals to breed to enhance a desired trait or minimize risk of undesired traits. In another example, the disclosed methods may be used in crop genetics. For example, the disclosed methods may allow for genetic splicing or selective crosses that may increase resistance to diseases or increase yield in specific environments.

In some examples the methods can be used to determine whether a subject has a disease by analyzing the interaction data according that is outputted. Examples of diseases that the method can detect include Parkinson's disease, cancer, hypertension, or Schizophrenia. If a disease is detected, then a drug can be administered to the patient. For example, if the patient has Parkinson's disease suitable drugs may include amantadine, apomorphine, bextropine, biperiden, bromocriptine, or cabergoline. If the patient has Schizophrenia, a suitable drug may include aripiprazole, asenapine, brexpiprazole, cariprazine, clozapine, iloperidone, lurasidone, olanzapine, paliperidone, quetiapine, risperidone, or ziprasidone

### EXAMPLES

Various embodiments of the present disclosure can be better understood by reference to the following Examples which are offered by way of illustration. The present disclosure is not limited to the Examples given herein.

### Example 1: Discovery of Between-Pathway Interactions in a Parkinson's Disease Cohort

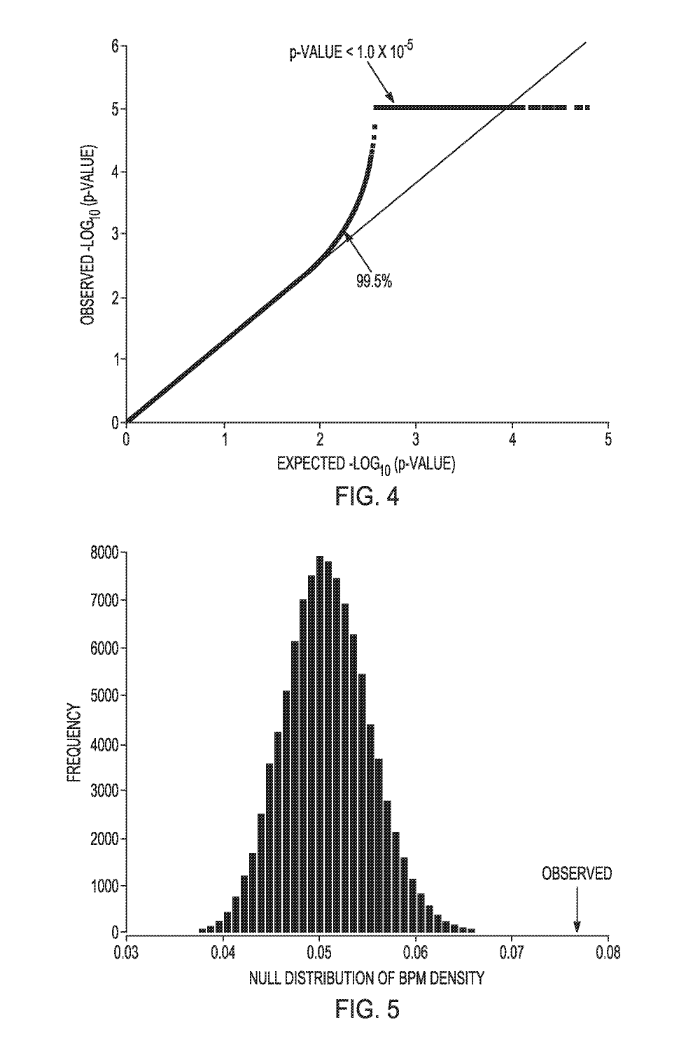

In one example, BridGE was applied to identify between pathway interactions in a genome-wide association study of Parkinson's disease (PD). While several early studies based on familial aggregation estimated that PD has low heritability, more recent work estimated a substantial heritable component (20%˜40%) across a variety of GWAS designs and suggested that previous low estimates were likely due to an insufficient number of confirmed PD cases. Although a relatively large number of variants have been associated singly with PD, a recent study estimated that the loci discovered to date are able to explain only a small fraction (6%-7%) of the total heritable risk. The PD-NIA cohort used in this analysis consists of 519 patients and 519 ancestry-matched controls after balancing the population substructure. An example collection of 833 curated gene sets representing established pathways or functional modules from KEGG BioCarta, and Reactome and 658 of these pathways were represented in the PD-NIA cohort after filtering based on set size (minimum: 10 genes, maximum: 300 genes). After using both SNP-pathway membership permutations (100,000) and sample permutations (10) to establish global significance and correct for the multiple hypotheses tested, BridGE reported 2 pathway-pathway interactions (BPM) at a false discovery rate (FDR) of ≤0.05 one between the Golgi associated vesicle biogenesis and the FC epsilon receptor I (FcεRI) signaling pathway and the other between a Natural Killer T-cell (NKT) pathway and FcεRI signaling. This is shown in FIG. 4, which is a QQ plot comparing observed p-values (based on 100,000 SNP-pathway membership permutations) for all possible pathway-pathway interactions between the 685 pathways to the expected, uniform distribution (log 10 scale).

For the vesicle biogenesis-FcεRI signaling BPM there were 2309 SNP-SNP interactions observed across these two pathways, which is 1.5 fold higher than the expected number (1509) given the 5% global density SNP-level interaction network and 1.3 and 1.2 fold higher than the expected (1746 and 1950) given the marginal density of the two pathways (6% and 7%), respectively (p(X_{global}²)<1×10⁻¹⁶, p(X_{local}³)<1×10⁻¹⁶, pₚₑᵣₘ<1×10⁻⁵.

In contrast to the significance of this BPM, none of the single SNPs mapped to these two gene sets appeared significant after multiple hypothesis correction based on single-locus tests on this cohort. This is shown in FIG. 5, which is a null distribution of the SNP-SNP interaction density between the Golgi associated vesicle biogenesis pathway and Fc epsilon receptor I signaling pathway described in FIG. 4 based on 100.000 SNP permutations. The observed density for the Golgi associated vesicle biogenesis and Fc epsilon receptor I signaling interaction is indicated by the arrow and was not exceeded by any of the random instances (p<1×10-5).

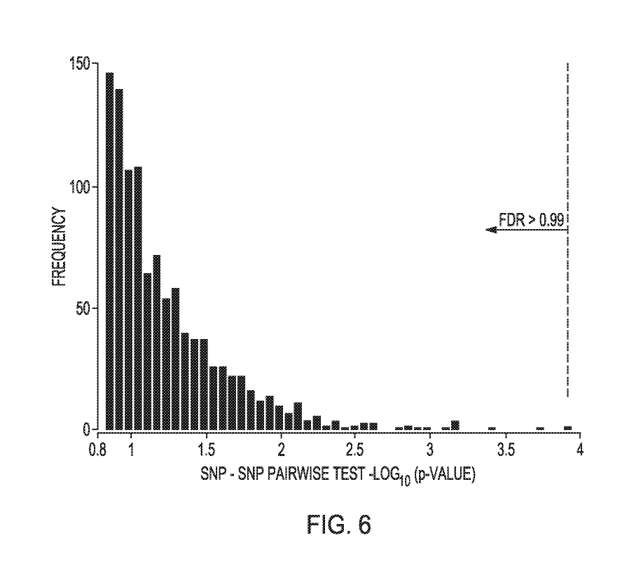

Furthermore, none of the individual SNP-SNP interactions between the two pathways appeared significant when tested independently under an additive disease model, or recessive or dominant models. This is shown in FIG. 6 which shows a distribution of p-values from individual tests for pairwise SNP-SNP interactions for SNP pairs supporting the pathway-pathway interaction, as measured by an additive disease model (−log 10 p-value). None of the SNP pairs are significant after multiple hypothesis correction (dashed line at the most significant SNP-SNP pair corresponds to FDR=0.99). Thus, in this cohort, the variants involved in this significant pathway-pathway interaction would be missed based on traditional univariate analysis or interaction tests that focus on individual SNP pairs.

To obtain a broader view of pathways with the potential to modulate PD risk, BPM interactions identified by BridGE at a less stringent cutoff were explored while still controlling the false discovery rate (FDR). For example, at an FDR of 0.25, 209 total significant BPMs were identified, which due to overlap among the pathways, could be summarized by a less redundant set of 34 BPMs (a maximum overlap coefficient of 0.25). Surprisingly, BridGE identified a BPM interaction associated with increased PD risk that connected genes encoding the ribosome (KEGG) and a Parkinson's Disease gene set (KEGG) that included several key genes that have been individually associated with Parkinson's disease: parkin (PARK2), ubiquitin carboxy-terminal hydrolase L1 (UCHL1), leucine-rich repeat kinase 2 (LRRK2), alpha synuclein (SNCA), and PTEN-induced putative kinase 1 (PINK1).

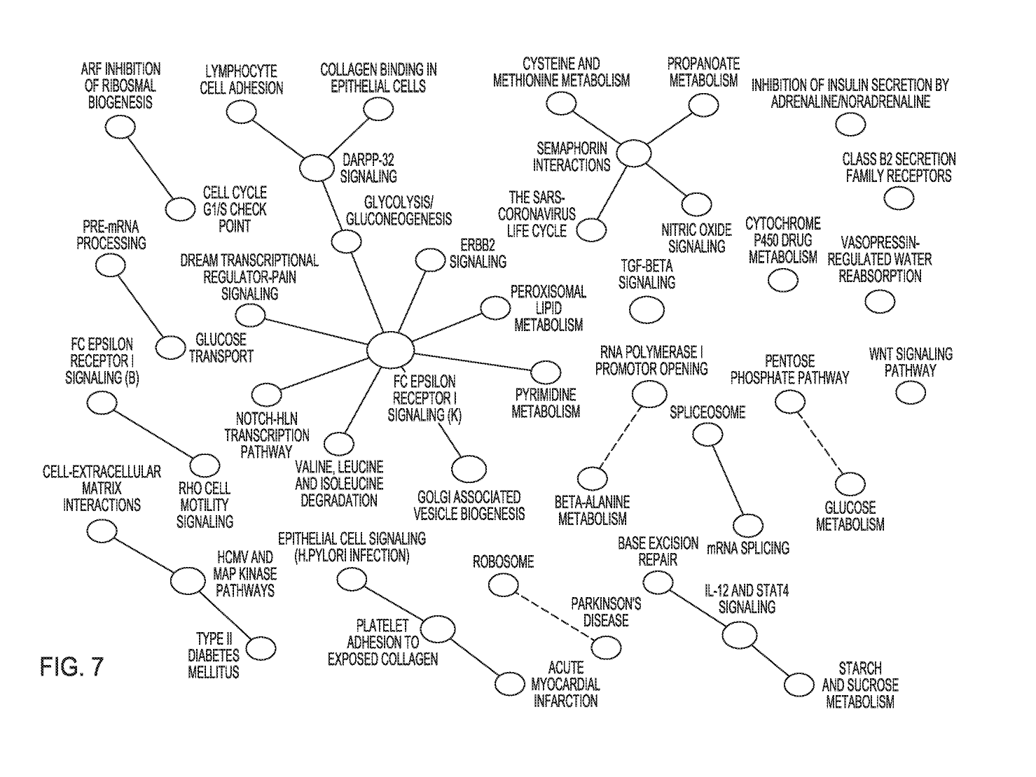

FIG. 7 is a global summary of between-pathway and within-pathway interactions discovered from a Parkinson's disease cohort (PD-NIA). Specifically FIG. 7 is a network representation of a set of significant (FDR≤0.25) between-pathway (BPM) and within-pathway interactions (WPM) that are associated with increased (dotted edges) or decreased (solid edges) risk of PD. Each node indicates the name of the pathway or gene set, and each edge represents a between-pathway interaction or within-pathway interaction (the self-loop edges). The size of the node reflects the number of interactions edges it has. The interaction between these Parkinson's related genes and the ribosome is intriguing given recent studies emphasizing the major role that the ribosome plays in protein quality control. Protein quality control mechanisms have strong relevance because accumulation of misfolded or aggregated proteins are a hallmark of several neurological diseases including Parkinson's.

Previous studies have specifically implicated several components of the ribosome as physically interacting with LRRK2 (leucine-rich repeat kinase 2), which is a known causal genetic variant for both familial and sporadic Parkinson's disease. Functional studies of mutant forms of LRRK2 in Drosophila and human cells confirmed aberrantly increased protein synthesis as a direct result of LRRK2 mutations as contributing to Parkinson's associated neurotoxicity. The result indicates that several different common variants in ribosomal proteins may increase risk associated with known Parkinson's variants. Several more of the pathways implicated in risk-associated interactions also showed strong relevance to Parkinson's disease. For example, the TGF-β signaling pathway (KEGG) was implicated in two different BPM interactions. TGF-β signaling has been associated with a neuroprotective role, specifically for midbrain dopaminergic neurons, and has been linked to neuronal phenotypes and neurodegeneration in mice. Also, TGFB2 was previously reported to have marginally significant association with Parkinson's disease in a targeted, indirect association study.

While 7 of the discovered BPMs were associated with increased risk for Parkinson's disease, a large majority (27 of 34) were associated with decreased risk. This may suggest that, in the case of Parkinson's disease, genetic interactions may be more frequently associated with protective effects, or alternatively, simply that there is more heterogeneity across the population in genetic interactions leading to increased risk, which would limit the ability to discover them. The FC epsilon receptor I (FcεRI) signaling pathway (KEGG) represented a major hub in the protective interaction network. FcεRI is the high-affinity receptor for Immunoglobulin E and is the major controller of the allergic response and associated inflammation. In general, immune-related inflammation has been frequently associated with Parkinson's disease and several immuno-modulating therapies pursued, but it remains unclear whether this is a causal driver of the disease or is rather a result of the neurodegeneration associated with disease progression.

There has been relatively little focus on the specific role of FcεRI in Parkinson's but recent observations support the relevance of this pathway to the disease. For example, associations have been reported between the occurrence of allergic rhinitis and increased susceptibility to PD. Furthermore, reduction of IL-13, one of the cytokines activated by FcεRI, was shown to have a protective effect in mouse models of PD, and also, galectin-3, which is known to modulate the FcεRI immune response, was shown to promote microglia activation induced by α-synuclein, a cellular phenotype associated with PD. These observations suggest that a hyperactive allergic response may predispose individuals to PD and support the speculation that protective interactions with FcεRI may be the result of variants that subtly reduce the activity of this pathway. In addition to several interactions with the FcεRI signaling pathway, our approach also reported two protective interactions involving the IL-12 and STAT4 signaling pathway, a pro-inflammatory cytokine that plays a major role in regulating both the innate and adaptive immune responses. Specifically, microglial cells both produce and respond to IL-12 and IFN-gamma, so these signals comprise a positive feedback loop that can support stable activation of microglia, which is a hallmark of Parkinson's disease, particularly in later stages. The prevalence of the FcεRI and IL-12 interactions among the discovered interactions suggests a major role for immune signaling as a causal driver of PD.

### Example 2: Evidence for within-Pathway Interaction Structures in Parkinson's Disease

In addition to finding combinations of SNPs between pairs of pathways (BPM), the method was also applied to discover instances of within-pathway SNP-SNP interaction enrichment. Indeed, focusing BridGE to discover within-pathway interactions in the PD-NIA Parkinson's cohort, at an FDR≤0.25, 2 significant WPMs were discovered. These were within the FcεRI signaling pathway (KEGG) and in the Golgi-associated vesicle biogenesis gene set (Reactome), and in both cases, minor allele combinations within the pathways were associated with decreased risk of PD. The combination of these pathways was also identified as one of the strongest protective between-pathway interactions, suggesting these pathways and the interaction between them are worth further investigation in the context of Parkinson's disease.

### Example 3: Replication of Pathway-Level Interactions in an Independent Parkinson's Disease Cohort

To validate the findings in Parkinson's disease, it was determined if the BPM and WPM interactions discovered in the PD-NIA cohort could be replicated in an independent cohort (PD-NGRC); 1947 cases and 1947 controls, all are of European ancestry; subjects overlapping with PD-NIA cohort were removed). Indeed, 9 BPMs of the 36 total interactions (34 BPMs, 2 WPMs) we discovered were nominally significant in the PD-NGRC based on all three significance criteria

(p(X_{global}²)≤0.05,p(X_{local}²)≤0.05,pₚₑᵣₘ≤0.05).

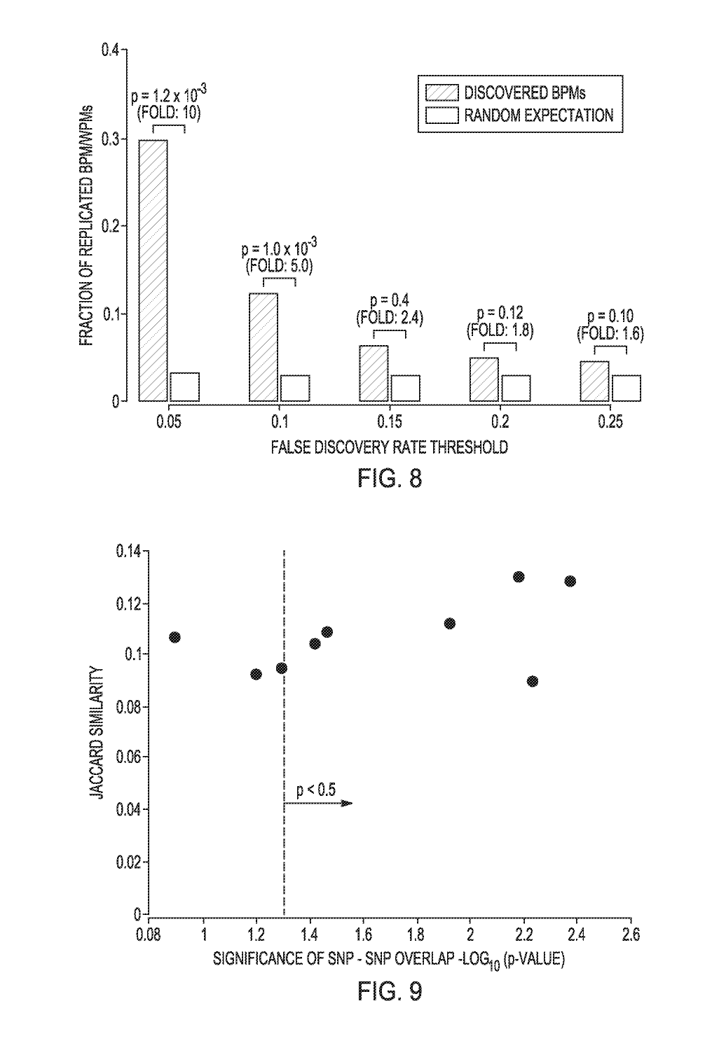

To assess the significance of this level of replication across the entire set of discoveries, the number of observed replicated BPMs and WPMs was compared at several different FDR cutoffs relative to the number expected by chance. This analysis confirmed that the discovered interactions indeed replicated more frequently than expected. This is shown in FIG. 8. FIG. 8 shows replication analysis of BPM and WPM interactions discovered from PD-NIA in an independent cohort (PD-NGRC). As shown, each BPM and WPM interaction discovered from the PD-NIA data was tested for replication in the PD-NGRC cohort. The collective significance of replication of the entire set of interactions discovered in PD-NIA was evaluated by measuring the fraction of significant BPM/WPMs discovered from PD-NIA that replicated in the PD-NGRC cohort (striped bars) at five different FDR cutoffs (x-axis). The random expectation for the number of replicating BPM/WPMs is plotted for comparison and was estimated based on 10 random sample permutations BPMs identified at more stringent FDR cutoffs showed a stronger tendency to replicate in the independent cohort (FDR≤0.05: fold enrichment of 15; FDR≤0.1: fold enrichment of 5.5), including the top-ranked BPM interaction discovered between Golgi associated vesicle biogenesis and the FC epsilon receptor I (FcεRI) signaling pathway.

One important question is which individual SNP-SNP interactions are supporting the discovered pathway-level interactions and whether these are similar across cohorts. For the 9 BPMs that were validated in the PD-NGRC cohort, the significance of the overlap between the SNP-SNP pair interactions supporting each of the validated BPMs in the PD-NIA and the PD-NGRC cohorts was evaluated and contrasted with the observed overlap to comparable statistics from 10 random sample permutations of the PD-NGRC cohort. Several individual BPMs exhibited significant overlap in their supporting SNP-SNP interactions, and collectively, the set of 9 replicated BPMs were strongly shifted toward higher than expected SNP-SNP interaction overlap (p=3.8×10⁻⁹). However, despite the statistically significant overlap among SNP-SNP interactions supporting replicated BPMs, the actual observed overlap in terms of fraction of pairs was relatively low for most cases, with all of them exhibiting a Jaccard similarity of less than 0.15. This is shown in FIG. 9, which is scatter plot of the significance of SNP-SNP interaction overlap in each of the replicated BPMs (−log 10 hypergeometric p-value) versus a direct measure of overlap (Jaccard similarity).

Thus, the same pathway-pathway interaction may be reflected by different sets of SNP-SNP interactions in different populations, or alternatively, this may reflect that the power for reliably pinpointing specific locus pairs may be quite limited (a key motivation for this study). In either case, the results suggest that to understand genetic interactions based on typical GWA cohort sizes, such combinations should be first analyzed at a pathway or functional module level rather than at the level of specific genome loci.

### Example 4: Discovery of Pathway-Level Interactions in Four Other Diseases

Given the promising results of the Parkinson's disease cohorts, BridGE was applied more broadly to another ten GWAS cohorts representing six other diseases (schizophrenia, breast cancer, hypertension, prostate cancer, pancreatic cancer, and type 2 diabetes). Significant pathway-level genetic interactions were discovered for five of the ten cohorts at FDR≤0.25 with discoveries for four additional diseases (schizophrenia, hypertension, prostate cancer, and breast cancer), indicating that genetic interactions may be associated with a variety of complex human diseases. The vast majority of the interactions discovered were disease-specific, and many of the pathways implicated in interactions showed strong relevance to the corresponding disease. For example, for schizophrenia, we discovered a protective within-pathway interaction in the nicotinate and nicotinamide metabolism pathway, and this interaction replicated in a second cohort (SZ-CATIE).

Nicotinic acid (vitamin B₃) supplements have been pursued as a treatment for schizophrenia dating back to the 1950s, although with some controversy. For breast cancer, several cancer-related gene sets were implicated in BPM interactions including p53 signaling, a basal cell carcinoma gene set, a melanoma gene set, as well as an interaction between MTA-3 related genes (Biocarta) and IL-17 signaling associated with increased disease risk. MTA-3 is a Mi-2/NuRD complex subunit that regulates an invasive growth pathway in breast cancer, and IL-17 levels have previously been associated with poor prognosis in breast cancer. In a hypertension cohort, two risk-associated interactions were identified involving hypoxia inducible factor (HIF), whose aberrant expression has been previously associated with hypertension. In prostate cancer, multiple risk-associated interactions involving the regulation of insulin were identified; metabolic syndrome has been recently associated with prostate cancer and serum insulin levels have been shown to correlate with risk of PC. In total, the disclosed approach discovered significant pathway-level interactions for seven of twelve cohorts on which it was run, producing results for five of seven diseases explored, suggesting the method will generalize to many different disease settings.

In addition to discovering interactions for several pathways highly relevant to each disease, application of the disclosed approach across multiple GWAS cohorts revealed another interesting trend. While multiple disease models were tested (additive, dominant, recessive, and combined dominant-recessive), for most diseases, most significant discoveries were reported under a dominant or combined model as measured by the SNP-SNP interaction metric. The relative frequency of interactions under a dominant vs. a recessive model may be largely due to the increased power to detect interactions between SNPs with dominant effects (compared to recessive effects). Specifically, individuals with both heterozygous and homozygous (minor allele) genotypes are affected by the minor allele in a dominant disease model, while only individuals with homozygous (minor allele) genotypes are affected by the minor allele in a recessive disease model. It is worth noting that the core of the BridGE approach, discovering genetic interactions in aggregation rather than in isolation, is readily adaptable to other disease models or other statistical measures. Indeed, the approach was applied using a standard additive model with a logistic regression-based statistical test as well as an approach that used the same genotype encoding as the dominant and recessive models but used a logistic regression-based interaction test. It was found that the interactions discovered using different measures and statistical tests did vary but that many pathway-pathway interactions discovered based on our measures of genetic interaction were also supported by other measures.

Results on seven GWAS cohorts representing five different diseases indicates that larger genetic interaction structures are indeed apparent in human disease populations and that these structures can be leveraged to discover significant pathway level interactions either between or within pathways. This has the potential to contribute substantially to our understanding of their genetic basis. For example, there have been approximately 50 singly associated loci (p≤1.0×10⁻⁷) and one reported genetic interaction (between FGF20 and MAOB) in the context of Parkinson's to date, so the discovery of 34 more pathway level interactions, several of which replicate in an independent cohort, significantly expands our knowledge of genetic variation associated with Parkinson's disease risk. The pathways and the interactions between them discovered by the approach could serve as the basis for generating more targeted hypotheses. For example, one potential strategy for developing more refined hypotheses from pathway level interactions could be to first leverage an approach like BridGE to find pathways with discover robust disease associations from genome-wide analysis SNPs, and then perform a more targeted search for individual SNP-SNP pairs that consistently explain these structures. The analysis of the Parkinson's cohort indicates that there may be overlap among the strongest SNP-SNP interactions supporting replicated pathway level interactions. Several directions should be explored in future work. First, further study of the effect of different measures within the proposed framework would be worthwhile. Second, the proposed framework currently depends on a set of pre-defined gene sets which may prevent the discovery of genetic interactions between sets of genes that are not part of well-characterized pathways. Developing methods that expand beyond the dependency on known pathways, possibly by leveraging other genomic data (e.g. protein-protein or protein-DNA interactions, gene expression data) while still constraining the search to expected network structures may improve the power of this approach.

### Example 5: Simulation-Based Estimation of Detection Limits for Pathway-Level Interactions

A simulation study was further used to characterize the statistical power of the disclosed approach as a function of pathway size, SNP-SNP interaction density, and marginal density of the pathways. Specifically, sets of non-overlapping BPMs of different sizes (ranging from 10×10 to 300×300) and densities (ranging from 5% to 10% interaction density) were embedded into SNP-SNP interaction networks. Additionally, the marginal pathway SNP-SNP interaction density was varied between 5% and 10% to evaluate the effect of overall pathway interaction density on the power of the approach. The BridGE algorithm was then applied to these simulated scenarios to assess its power in detecting these embedded patterns. The simulation results suggest that the method's sensitivity in detecting BPMs is highly related to the size of the two pathways involved and the density of SNP-SNP interactions connecting them. For example, for a 50×50 BPM (i.e. two interacting pathways with 50 SNPs each) to meet the same significance threshold reported earlier for PD-NIA, a SNP-SNP interaction density of at least 7% (with pathway marginal density of 5%) or at least 9% (with pathway marginal density of 10%) may be required. In contrast, a 200×200 BPM could be discovered with a density of only 6% or 7%, respectively. Combinations of smaller pathways (≤10 SNPs associated with each) require substantially higher interaction density to be discovered under these conditions (e.g., >>10%).

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

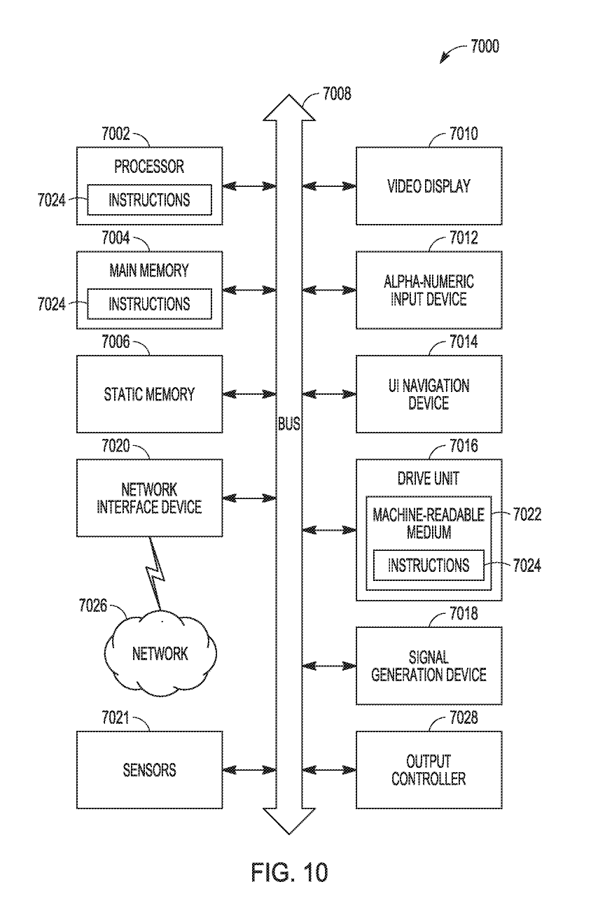

FIG. 10 illustrates a block diagram of an example machine 7000 upon which any one or more of the techniques (e.g., methodologies) discussed herein may be executed. For example, the machine 7000 may execute the BridGE method. In alternative embodiments, the machine 7000 may operate as a standalone device or may be connected (e.g., networked) to other machines. In a networked deployment, the machine 7000 may operate in the capacity of a server machine, a client machine, or both in server-client network environments. In an example, the machine 7000 may act as a peer machine in peer-to-peer (P2P) (or other distributed) network environment. The machine 7000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as FIG. 3, cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 7000 may include a hardware processor 7002 (e.g., a central processing unit (CPU), a graphics processing unit (GPU), a hardware processor core, or any combination thereof), a main memory 7004 and a static memory 7006, some or all of which may communicate with each other via an interlink (e.g., bus) 7008. The machine 7000 may further include a display unit 7010, an alphanumeric input device 7012 (e.g., a keyboard), and a user interface (UI) navigation device 7014 (e.g., a mouse). In an example, the display unit 7010, input device 7012 and UI navigation device 7014 may be a touch screen display. The machine 7000 may additionally include a storage device (e.g., drive unit) 7016, a signal generation device 7018 (e.g., a speaker), a network interface device 7020, and one or more sensors 7021, such as a global positioning system (GPS) sensor, compass, accelerometer, or other sensor. The machine 7000 may include an output controller 7028, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 7016 may include a machine readable medium 7022 on which is stored one or more sets of data structures or instructions 7024 (e.g., software) embodying or utilized by any one or more of the techniques or functions described herein. The instructions 7024 may also reside, completely or at least partially, within the main memory 7004, within static memory 7006, or within the hardware processor 7002 during execution thereof by the machine 7000. In an example, one or any combination of the hardware processor 7002, the main memory 7004, the static memory 7006, or the storage device 7016 may constitute machine readable media.

While the machine readable medium 7022 is illustrated as a single medium, the term “machine readable medium” may include a single medium or multiple media (e.g., a centralized or distributed database, and/or associated caches and servers) configured to store the one or more instructions 7024.

The term “machine readable medium” may include any medium that is capable of storing, encoding, or carrying instructions for execution by the machine 7000 and that cause the machine 7000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM): Solid State Drives (SSD): and CD-ROM and DVD-ROM disks. In some examples, machine readable media may include non-transitory machine readable media. In some examples, machine readable media may include machine readable media that is not a transitory propagating signal.

The instructions 7024 may further be transmitted or received over a communications network 7026 using a transmission medium via the network interface device 7020. The Machine 7000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WIMAX®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 7020 may include one or more physical jacks (e.g., Ethernet, coaxial, or phone jacks) or one or more antennas to connect to the communications network 7026. In an example, the network interface device 7020 may include a plurality of antennas to wirelessly communicate using at least one of single-input multiple-output (SIMO), multiple-input multiple-output (MIMO), or multiple-input single-output (MISO) techniques. In some examples, the network interface device 7020 may wirelessly communicate using Multiple User MIMO techniques.

All publications, patents, and patent applications mentioned in this specification are herein incorporated by reference to the same extent as if each individual publication, patent, or patent application was specifically and individually indicated to be incorporated by reference. In the event that the definition of a term incorporated by reference conflicts with a term defined herein, this specification shall control.

### Additional Embodiments

The following exemplary embodiments are provided, the numbering of which is not to be construed as designating levels of importance:

Embodiment 1 provides a computer implemented method comprising:

using a computer processor to perform the operations of:
constructing a nucleic acid mutation interaction network based upon nucleic acid pair-level interactions of a genetic sample scored under at least one disease model;
performing a thresholding and binarization process on the nucleic acid pair interactions to derive an interaction network;
testing pairs of pathways of the interaction network for either between pathway model (BPM) or within pathway model (WPM) enrichment of nucleic acid-nucleic acid mutation pair interaction; and
outputting nucleic acid-nucleic acid mutation pair interaction data.

Embodiment 2 provides the method of Embodiment 1, further comprising performing quality control of the genetic sample.

Embodiment 3 provides the method of Embodiment 2, wherein performing quality control of the genetic sample comprises determining an identical by descent (IBD) score of the genetic sample and removing at least one genetic sample with an IBD score above a predetermined threshold value.

Embodiment 4 provides the method of Embodiment 2, wherein performing quality control of the genetic samples comprises:

mapping a nucleic acid mutation to a gene in a collection of pathways and

associating the mutation with one of the pathways.

Embodiment 5 provides the method according to any one of Embodiments 1-4, wherein thresholding and binarization comprises establishing an interaction between nucleic acid mutations when associated with a phenotype for the mutation exceeds a threshold value.

Embodiment 6 provides the method according to any one of Embodiments 1-5, wherein the nucleic acid mutation is chosen from single nucleotide polymorphisms, insertions, deletions, or translocation, or combinations thereof.

Embodiment 7 provides the method according to any one of Embodiments 1-6, wherein at least one disease model is chosen from an additive model, a recessive model, a dominant model, or a combination of a recessive and dominant model.

Embodiment 8 provides a non-transitory machine readable medium, including instructions, which when executed by a machine, cause the machine to perform the operations comprising:

constructing a nucleic acid mutation interaction network based upon nucleic acid pair-level interactions of a genetic sample scored under at least one disease model;

performing a thresholding and binarization process on the nucleic acid pair interactions to derive an interaction network;

testing pairs of pathways of the interaction network for either between pathway model (BPM) or within pathway model (WPM) enrichment of nucleic acid-nucleic acid mutation pair interaction; and

outputting nucleic acid-nucleic acid mutation pair interaction data.

Embodiment 9 provides the non-transitory machine readable medium of Embodiment 8, wherein constructing the nucleic acid mutation interaction network comprises:

determining whether a nucleic acid-nucleic acid mutation pair interaction density exceeds a threshold value; and

associating the mutation pair interaction with a phenotype.

Embodiment 10 provides the non-transitory machine readable medium according to any one of Embodiments 8-9, further comprising performing quality control of the genetic sample.

Embodiment 11 provides the non-transitory machine readable medium of Embodiment 10, wherein performing quality control of the genetic samples comprises:

mapping a nucleic acid mutation to a gene in a collection of pathways and

associating the mutation with one of the pathways.

Embodiment 12 provides the non-transitory machine readable medium according to any one of Embodiments 8-11, wherein thresholding and binarization comprises establishing an interaction between nucleic acid mutations when associated with a phenotype for the mutation exceeds a threshold value.

Embodiment 13 provides the non-transitory machine readable medium according to any one of Embodiments 8-12, wherein the nucleic acid mutation is chosen from a single nucleotide polymorphism, an insertion, a deletion, or a frameshift.

Embodiment 14 provides the non-transitory machine readable medium according to any one of Embodiments 8-13, wherein at least one disease model is chosen from an additive model, a recessive model, a dominant model, or a combination of a recessive and dominant model.

Embodiment 15 provides a system comprising:

a processor; and

a memory, the memory including instructions, which when executed by a machine, cause the machine to perform the operations comprising:
constructing a nucleic acid mutation interaction network based upon nucleic acid pair-level interactions of a genetic sample scored under at least one disease model;
performing a thresholding and binarization process on the nucleic acid pair interactions to derive an interaction network;
testing pairs of pathways of the interaction network for either between pathway model (BPM) or within pathway model (WPM) enrichment of nucleic acid-nucleic acid mutation pair interaction; and
outputting nucleic acid-nucleic acid mutation pair interaction data.

Embodiment 16 provides the system of Embodiment 15, wherein performing quality control of the genetic samples comprises:

mapping a nucleic acid mutation to a gene in a collection of pathways and

associating the mutation with one of the pathways.

Embodiment 17 provides the system according to any one of Embodiments 15-16, wherein thresholding and binarization comprises establishing an interaction between nucleic acid mutations when associated with a phenotype for the mutation exceeds a threshold value.

Embodiment 18 provides the system according to any one of Embodiments 15-17, wherein the nucleic acid mutation is chosen from a single nucleotide polymorphism, an insertion, a deletion, or a frameshift.

Embodiment 19 provides the system according to any one of Embodiments 15-18, wherein the at least one disease model is chosen from an additive model, a recessive model, a dominant model, or a combination of a recessive and dominant model.

Embodiment 20 provides the system of any one of Embodiments 15-19, further comprising performing quality control of the genetic sample.

Embodiment 21 provides a method for detecting a disease in patient comprising:

obtaining a genetic sample from a patient;

analyzing the interaction data according to any one of Embodiments 1-20 from the genetic sample;

determining whether the interaction data is associated with the disease; and

treating the patient.

Embodiment 22 provides the method of Embodiment 21, wherein the disease is chosen from Parkinson's disease, cancer, hypertension, or Schizophrenia.

Embodiment 23 provides the method of any one of Embodiments 21-22, wherein treating the patent comprises administering a drug.

1. A computer implemented method comprising:
using a computer processor to perform the operations of:
constructing a nucleic acid mutation interaction network based upon nucleic acid pair-level interactions of a genetic sample scored under at least one disease model;
performing a thresholding and binarization process on the nucleic acid pair interactions to derive an interaction network;
testing pairs of pathways of the interaction network for either between pathway model (BPM) or within pathway model (WPM) enrichment of nucleic acid-nucleic acid mutation pair interaction; and
outputting nucleic acid-nucleic acid mutation pair interaction data.

2. The method of claim 1, further comprising performing quality control of the genetic sample.

3. The method of claim 2, wherein performing quality control of the genetic sample comprises determining an identical by descent (IBD) score of the genetic sample and removing at least one genetic sample with an IBD score above a predetermined threshold value.

4. The method of claim 2, wherein performing quality control of the genetic samples comprises:
mapping a nucleic acid mutation to a gene in a collection of pathways and
associating the mutation with one of the pathways.

5. The method of claim 1, wherein thresholding and binarization comprises establishing an interaction between nucleic acid mutations when associated with a phenotype for the mutation exceeds a threshold value.

6. The method of claim 1, wherein the nucleic acid mutation is chosen from single nucleotide polymorphisms, insertions, deletions, or translocation, or combinations thereof.

7. The method of claim 1, wherein at least one disease model is chosen from an additive model, a recessive model, a dominant model, or a combination of a recessive and dominant model.

8. A non-transitory machine readable medium, including instructions, which when executed by a machine, cause the machine to perform the operations comprising:
constructing a nucleic acid mutation interaction network based upon nucleic acid pair-level interactions of a genetic sample scored under at least one disease model;
performing a thresholding and binarization process on the nucleic acid pair interactions to derive an interaction network;
testing pairs of pathways of the interaction network for either between pathway model (BPM) or within pathway model (WPM) enrichment of nucleic acid-nucleic acid mutation pair interaction; and
outputting nucleic acid-nucleic acid mutation pair interaction data.

9. The non-transitory machine readable medium of claim 8, wherein constructing the nucleic acid mutation interaction network comprises:
determining whether a nucleic acid-nucleic acid mutation pair interaction density exceeds a threshold value; and
associating the mutation pair interaction with a phenotype.

10. The non-transitory machine readable medium of claim 8, further comprising performing quality control of the genetic sample.

11. The non-transitory machine readable medium of claim 10, wherein performing quality control of the genetic samples comprises:
mapping a nucleic acid mutation to a gene in a collection of pathways and
associating the mutation with one of the pathways.

12. The non-transitory machine readable medium of claim 8, wherein thresholding and binarization comprises establishing an interaction between nucleic acid mutations when associated with a phenotype for the mutation exceeds a threshold value.

13. The non-transitory machine readable medium of claim 8, wherein the nucleic acid mutation is chosen from a single nucleotide polymorphism, an insertion, a deletion, or a frameshift.

14. The non-transitory machine readable medium of claim 8, wherein at least one disease model is chosen from an additive model, a recessive model, a dominant model, or a combination of a recessive and dominant model.

15. A system comprising:
a processor; and
a memory, the memory including instructions, which when executed by a machine, cause the machine to perform the operations comprising:
constructing a nucleic acid mutation interaction network based upon nucleic acid pair-level interactions of a genetic sample scored under at least one disease model;
performing a thresholding and binarization process on the nucleic acid pair interactions to derive an interaction network:
testing pairs of pathways of the interaction network for either between pathway model (BPM) or within pathway model (WPM) enrichment of nucleic acid-nucleic acid mutation pair interaction; and
outputting nucleic acid-nucleic acid mutation pair interaction data.

16. The system of claim 15, wherein performing quality control of the genetic samples comprises:
mapping a nucleic acid mutation to a gene in a collection of pathways and
associating the mutation with one of the pathways.

17. The system of claim 15, wherein thresholding and binarization comprises establishing an interaction between nucleic acid mutations when associated with a phenotype for the mutation exceeds a threshold value.

18. The system of claim 15, wherein the nucleic acid mutation is chosen from a single nucleotide polymorphism, an insertion, a deletion, or a frameshift.

19. The system of claim 15, wherein the at least one disease model is chosen from an additive model, a recessive model, a dominant model, or a combination of a recessive and dominant model.

20. The system of claim 15, further comprising performing quality control of the genetic sample.
